(19) United States
(12) Patent Application Publication
(10) Pub. No.: US 2009/0137319 A1
(43) Pub. Date: May 28, 2009

(54) Command Distribution Method, and Multimedia Apparatus and System Using the Same for Playing Games

(75) Inventors: SHIH CHIN LIN, Hsinchu Hsien (TW); YI TA TSAI, Hsinchu Hsien (TW); SHAO CHIH WU, Hsinchu Hsien (TW); CHUAN WEN CHEN, Hsinchu Hsien (TW); NAI SHENG CHENG, Hsinchu Hsien (TW)

Correspondence Address: WPAT, PC, 7225 BEVERLY ST., ANNANDALE, VA, 22003, US

(73) Assignee: MSTAR SEMICONDUCTOR, INC., Hsinchu Hsien (TW)

(21) Appl. No.: 12/269,186

(22) Filed: Nov. 12, 2008

(30) Foreign Application Priority Data
Nov. 23, 2007 (TW) 096144589

(51) Int. Cl. G06F 17/00

(52) U.S. Cl. 463/42

(57) ABSTRACT

A command distribution method, and multimedia apparatus and system using the same for playing games are concerned. The game system includes a game platform, a signal transmission module and an audio/video playing device. The audio/video playing device, coupled to the game platform via the signal transmission module, receives a command from the signal transmission module, and processing the command by way of a driver. The command is then transmitted to a data processing engine to be executed so as to generate an output signal. The command distribution method comprises steps of receiving a command from a game platform by an audio/video playing device, identifying a type to which the command corresponds among a plurality of types, and transmitting the command to be processed by a corresponding data processing engine according to the identified type, thereby generating an output signal.

### FIELD OF THE INVENTION

The present invention relates to a command distribution method, and multimedia apparatus and system using the same for playing games.

### BACKGROUND OF THE INVENTION

Game device industry is an integral part of electronics industry, and is divided into two categories. The first category is hardware development and manufacturing of game platforms, such as XBox®, PS2®, PS3®, PSP®, and Wii® provided by Microsoft®, Sony® and Nintendo®, respectively. The second category is development of game software. Generally, game software of a same content exists in various versions for use in different game platforms. For example, a Major League Baseball® (MLB) game launched by Electronic Arts, a US-based company, is featured in Xbox®, PS2®, PS3®, Wii® and personal computer (PC) versions. Referring to FIG. 1 showing a schematic diagram of a system of a prior game device, a game platform 11 such as the aforesaid Xbox®, PS2®, PS3®, Wii®, and PC for executing game software, via an audio/video signal line, outputs standard audio/video signals that can be directly played, to an audio/video playing device 12 such as a television or a combination of a display and speakers. The standard audio/video signals may be High Definition Multimedia Interface (HDMI) signals.

From a game platform manufacture's point of view, an ultimate goal is expanding market share to increase earnings. To correspond to different game platforms, it is only natural to have game software in various versions that are not compatible with one another. However, from a user's point of view, costly hardware and software, as well as incompatibility of the same indeed cause immense trouble for players.

### SUMMARY OF THE INVENTION

Therefore, the primary object of the invention is to overcome the foregoing drawbacks of prior art.

The present invention provides a game system comprising a game platform for executing an application program, which calls an application program interface (API) to produce a command to be processed by way of a first driver for output; a signal transmission module coupled to the game platform, and for receiving and further transmitting the command from the first driver; and an audio/video playing device coupled to the signal transmission module, and for receiving the command to be processed by way of a second driver, with the command further transmitted to a data processing engine to be executed, so as to generate an output signal.

The invention also provides an audio/video playing device being operable with a game platform. The game platform executes an application program, which calls an API to produce a command to be processed by way of a first driver for output. The audio/video playing device, being coupled to the game platform via a signal transmission module, comprises a second driver and a data processing engine. The audio/video playing device receives the command from the signal transmission module, and transmits the command processed by the second driver to the data engine to be executed, so as to generate an output signal.

The invention yet provides a command distribution method comprising steps of receiving a command from a game platform, identifying a type to which the command corresponds among a plurality of types, and transmitting the command to a corresponding data engine for processing according to the identified type to generate an output signal.

The invention further provides a command distribution method for use in a game platform and an audio/video playing device, comprising steps of producing a command with a command identification (ID) from a built-in driver set in the game platform and transmitting the command to the audio/video playing device; receiving the command by the audio/video playing device; identifying a type to which the command corresponds among a plurality of types according to the command ID; and transmitting the command to a data processing engine set for processing to generate an output signal.

### BRIEF DESCRIPTION OF THE DRAWINGS

The present invention will become more readily apparent to those ordinarily skilled in the art after reviewing the following detailed description and accompanying drawings, in which:

FIG. 1 shows a schematic diagram of a structure of a prior game device.

FIG. 2 shows a schematic diagram of a function block of a game system according to the invention.

FIG. 3 shows a schematic diagram of a function block according to a first preferred embodiment of the invention.

FIG. 4 shows a schematic diagram of a function block according to a second preferred embodiment of the invention.

FIG. 5 shows a flow chart of a method for distributing commands according to one embodiment of the invention.

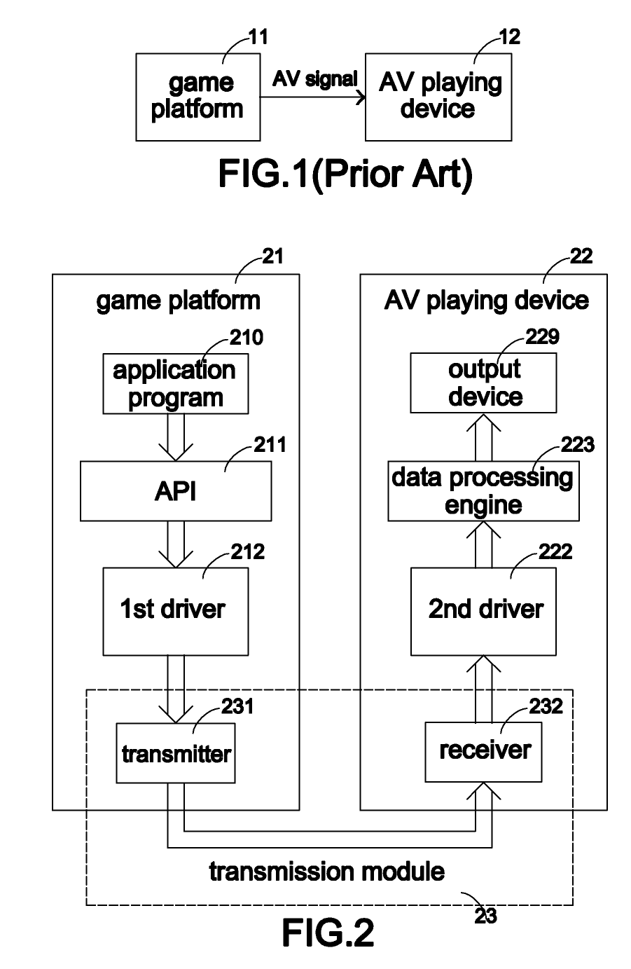

### DETAILED DESCRIPTION OF THE PREFERRED EMBODIMENT

Referring to FIG. 2 showing a schematic diagram of a function block of a game system according to the invention, the game system comprises a game platform 21, and an audio/video playing device 22. The game platform 21 is coupled to the audio/video playing device 22, e.g. by way of plugging. An operation system of the audio/video playing device 22 may be different from that of the game platform 21. The game platform 21 executes an application program 210, which may be game software that calls functions of an application program interface (API) 211 to produce commands and data. The commands and data produced by the API 211 are processed and transmitted by way of a first driver 212, and converted into a predetermined format to be transmitted to a receiver 232 in the audio/video playing device 22 via a transmitter 231 through wired or wireless transmission. The transmitter 231 and the receiver 232 are regarded as a transmission module 23. Having been processed into the predetermined format, the commands and data are received and identified by a second driver 222, which processes and transmits the received commands and data to a data processing engine 223 for execution and algorithm, such that audio/video signals representing audio and visual effects of the game software are generated therefrom and then output from an output device 229 of the audio/video playing device 22.

In this embodiment, the game platform 21 does not require any data processing engine. Hardware such as commonly seen graphic engine, audio engine and video engine may all be eliminated to significantly reduce hardware costs and circuit complexity of the game platform 21, thereby lowering cost of the game platform 21 to achieve a primary object of the invention. The audio/video playing device 22, such as a digital television or a display, is generally equipped with built-in hardware components for completing the aforesaid data processing engine 233, such as central processing unit (CPU), digital signal processor (DSP), video decoder and graphic processor extensively embedded in digital televisions. The wired or wireless signal transmission module 23 may be accomplished using existing standards, like wired buses, e.g. Universal Serial Bus (USB) and IEEE 1394, or wireless transmission modules like Bluetooth, Wi-Fi and Wi-max. A digital television with USB will be exemplified below.

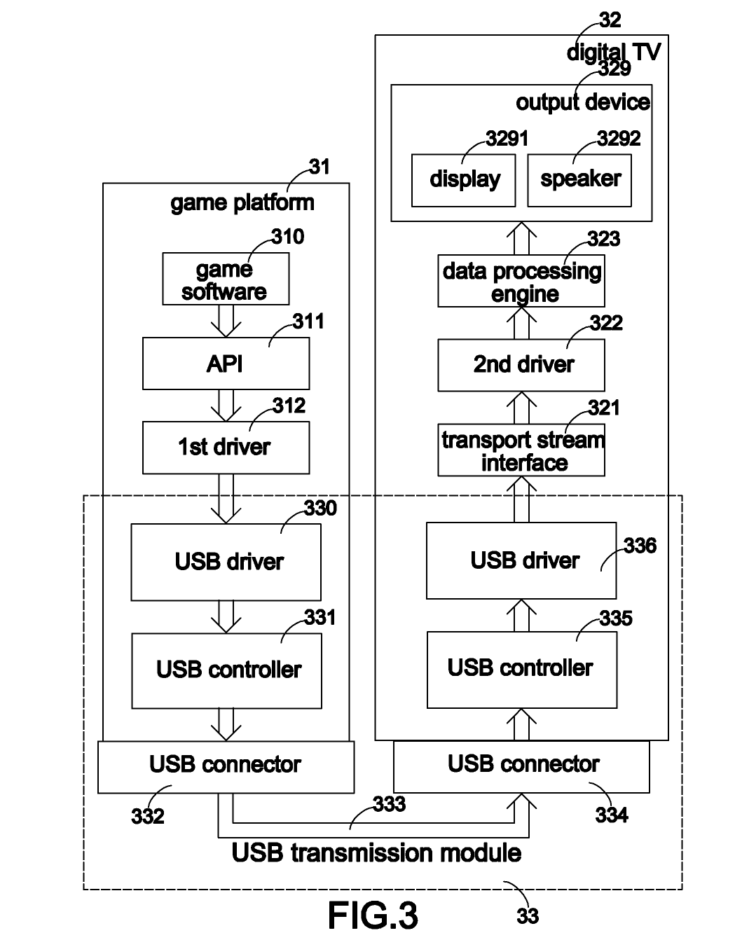

Referring to FIG. 3 showing a schematic diagram of a function block according to a first preferred embodiment of the foregoing system, a game platform 31 executes game software 310, which calls an API 311 to produce multimedia commands. By way of a first driver 312, the multimedia commands produced by the API 311 are processed and converted into a predetermined format, such as a transport stream package (TSP) that can be transmitted within the digital television 32, for subsequent transmission. In this embodiment, the signal transmission module is embodied as a USB transmission module 33. The game platform 31 and the digital television 32 are provided with required software and hardware, respectively, including a USB driver 300, a USB controller 331, USB connectors 332 and 334, a USB connector 335, and a USB driver 336, which are connected by a USB cable 333. Upon receipt of a packet containing the multimedia command in TSP format, the digital television 32 unloads the packet, and using a transport stream interface 321 in the digital television 32 for reception and conversion, allows the multimedia command in TSP format first to be transmitted in the digital television, and then be sent to a corresponding second driver 322. The second driver 322 transmits the multimedia command to a corresponding data processing engine 323, such that audio/video signals representing audio and visual effects of the game software are generated therefrom and then output via an output device 329 comprising a display 3291 and a speaker 3292.

However, multimedia commands exist in various forms. For example, there are vector 2D, vector 3D, audio, and streaming media commands and data. As a result, the API 311, the first driver 312, the second driver 322 and the data processing engine 323 have to be different and adapted to processes various multimedia commands. Published by The Khronos Group, below is Open Standards for Media Authoring and Acceleration, in which relations between various standards are illustrated.

| Type of | | | | Streaming |
|---|---|---|---|---|
| Command | Vector 2D | Vector 3D | Audio | Media |
| API | OpenVG | OpenGL ES | OpenSL ES | OpenMax |
| First Driver | VG Host | GL Host | SL Host | Max Host |
| | Driver | Driver | Driver | Driver |
| Second | VG Client | GL Client | SL Client | Max Client |
| Driver | Driver | Driver | Driver | Driver |
| Data | Graphic | Graphic | Audio | Video |
| Processing | Engine | Engine | Engine | Engine and |
| Engine | | | | Audio |
| | | | | Engine |
| Output | Display | Display | Amplifier | Display and |
| Device | | | | Speaker |

The foregoing API 311, the first driver 312, the second driver 322, and the data processing engine 323 have corresponding operations based on various commands. Suppose the game software 310 needs to produce vector 3D graphic commands, the API 311 may be an OpenGL ES API, the first driver 312 may be a GL host driver, the second driver 322 may be a GL client driver and the data processing engine 323 may be a graphic engine for operation, and the output device may be the display 3291 for display. Using such, the game platform 31 may skip internal hardware for processing vector 3D graphic commands, thereby lowering hardware costs of the game platform 31.

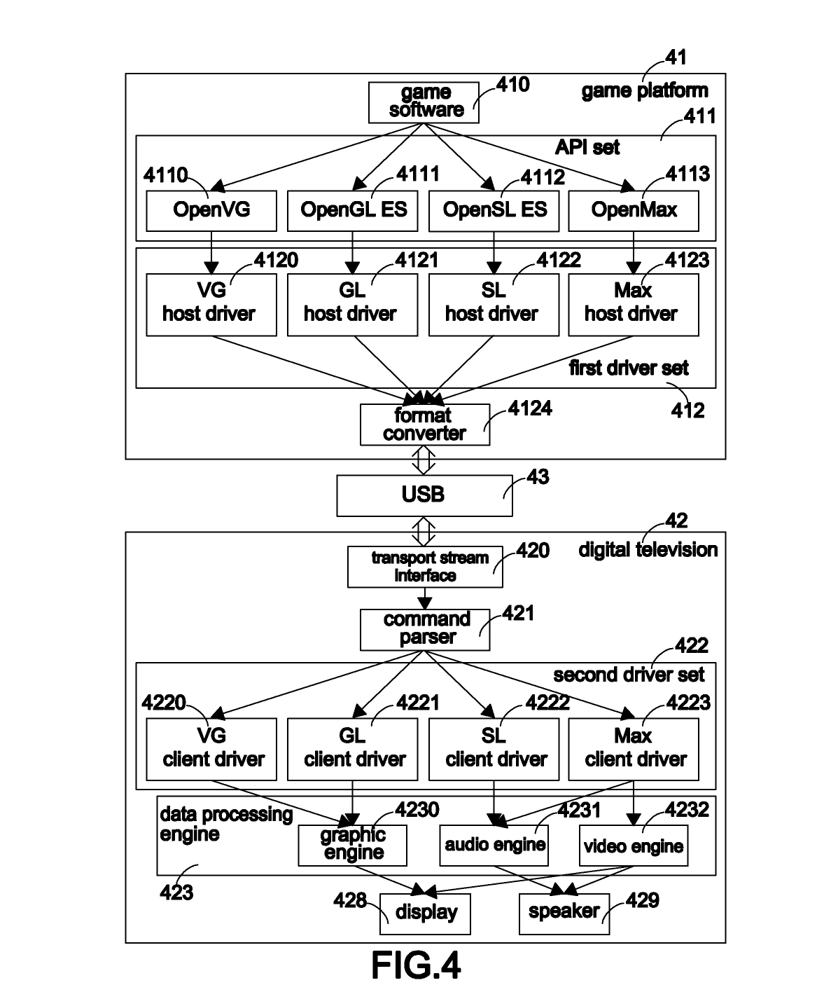

Referring to FIG. 4 showing a schematic diagram of a function block according to a second preferred embodiment, hardware in the game platform 31 can be further reduced. A game platform 41 executes game software 410, which calls an API set 411 having multiple multimedia APIs such as OpenVG_4110, OpenGL ES_4111, OpenSL ES_4112, OpenMax 4113, DirectX or the like to produce various multimedia commands. Via a first driver set 412 comprising a VG host driver 4120, a GL host driver 4121, an SL host driver 4122 and a Max host driver 4123, and a format converter 4124, the multimedia commands produced by the API set 411 are processed and converted into a predetermined format such as the aforesaid TSP format, sent to a signal transmission module such as a USB 43, packaged to a predetermined signal transmission format such as the aforesaid USB format, and transmitted to a digital television 42. When the multimedia commands in USB format are transmitted to the digital television 42, which is the audio/video playing device, packets in USB format are unloaded. With a transport stream interface 420 in the digital television 42, the multimedia commands are transmitted in the digital television in TSP format converted by a transport stream interface 420, and sent to a command parser 421 for parsing. According to parsed results, the multimedia commands are correspondingly transmitted to a second driver set 422 comprising a VG client driver 4220, a GL client driver 4221, an SL client driver 4222 and a Max client driver 4223, and are correspondingly processed by a data processing engine set 423 comprising a graphic engine 4230, an audio engine 4231 and a video engine 4232, whereby audio/video signals representing audio and visual effects of the game software are generated therefrom and output via a display 428 and a speaker 429 in the digital television 42.

Therefore, the game platform 41 does not require specific built-in hardware for processing multimedia commands, thus lowering hardware costs of the game platform 41. The format converter 4124 which is originally provided in the first driver 312 in the first preferred embodiment, is separated from the first driver 312 in the second preferred embodiment in order to be shared by multiple drivers to simplify the system structure. The format converter 4124 packages commands to a predetermined format. In this embodiment, by parsing commands, the commands may be packaged into three types: (1) single command: command ID+data size+data; (2) packet command: command ID+data size+data+packet data; and (3) null command. The data size in the single command may vary according different types of commands. Takeing a ViewPort command for instance, the data size in each ViewPort command is the same, and in fact represents two numbers namely length and width. The length of packet data in a packet command varies with data contents. For example, for a common LoadTexture command, apart from length and width information, data thereof also includes color standard like RGB888. The length of packet data containing texture is determined by data contents, which are length, width and color standard. A null command, on the other hand, does not contain any attached information. For example, a finish command represents completion of an operation while containing no attached information. In this embodiment, multimedia commands may be completely transmitted in form of the three foregoing commands, which may contain data such as pixel data for video reconstruction, position and offset for video reconstruction, sequence for video reconstruction, and data for audio reconstruction. To effectively distinguish command types from one another, command IDs may be classified according to types of APIs, namely OpenVG, OpenGL ES, OpenSL ES, and OpenMax. Upon reception of multimedia commands packaged in the predetermined format, the command parser 421 distributes the commands according to the command IDs thereof, and transmits the commands to corresponding client drivers in the second driver set 422.

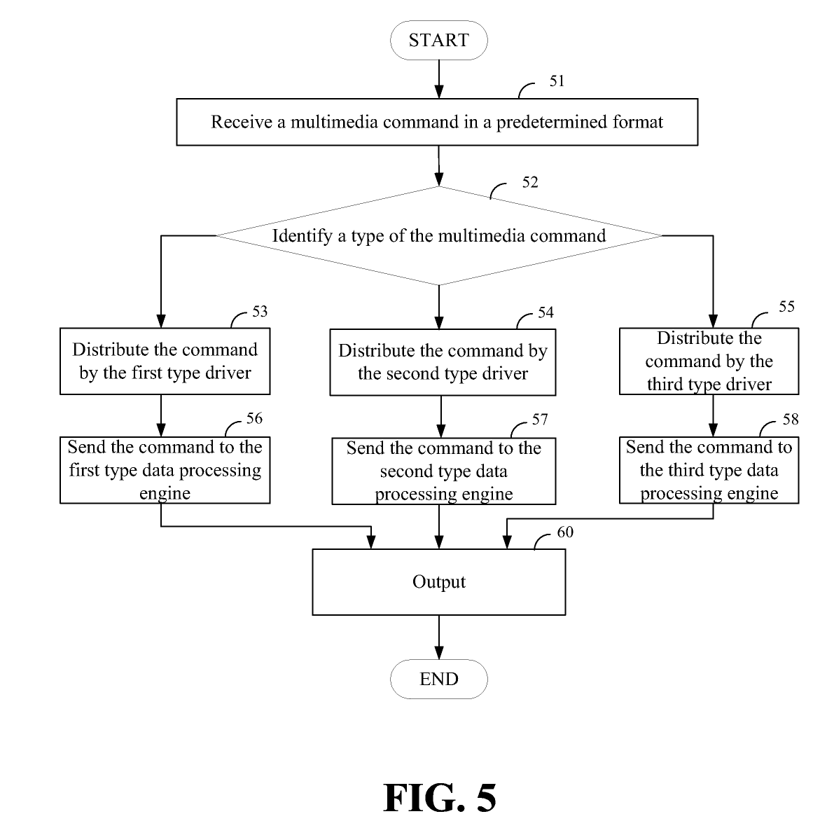

FIG. 5 shows a flow chart to clearly explain determination and distribution steps of the aforesaid commands according to the invention. In step 51, a digital television receives a multimedia command in a predetermined format. In step 52, the command parser 421 parses the command ID in the command, identifies to which type the multimedia command belongs, and distributes the command accordingly to a first-type driver, a second-type driver and a third-type driver for processing in step 53, step 54 and step 55, followed by sending the commands to corresponding data processing engines in step 56, step 57 and step 58 to generate corresponding multimedia signals to be played in step 60, so as to complete execution of the game software.

Conclusive from the above description, the invention reduces hardware costs and circuit complexity of the game platform, as well as achieving a system combining a multimedia API in various standards with a current audio/video playing device, so as to overcome shortcomings of prior art.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A game system, comprising:
a game platform, executing an application program, which calls an application program interface (API) to produce a command and output the command after processed by a first driver;
a signal transmission module, coupled to the game platform, for receiving and transmitting the command from the first driver; and
an audio/video playing device, coupled to the signal transmission module, for receiving the command to be processed by a second driver, and then transmitted to a data processing engine for execution, so as to generate an output signal.

2. The game system according to claim 1, wherein the API is a multimedia API producing a multimedia command.

3. The game system according to claim 1, wherein the first driver packages the command into a predetermined format, and the signal transmission module is a wired signal transmission module or a wireless signal transmission module.

4. The game system according to claim 3, wherein the wired signal transmission module is a Universal Serial Bus (USB) or an IEEE 1394 bus.

5. The game system according to claim 3, wherein the wireless transmission module is a Bluetooth transmission module.

6. The game system according to claim 1, wherein the audio/video playing device is independently provided outside of a housing of the game platform, and coupled to the signal transmission module by way of plugging; and comprises an operation system thereof being different from that of the game platform, the data processing engine comprises a graphic engine, an audio engine and a video engine, and the output signal is a video signal, a graphic signal, an audio signal, or an audio/video signal.

7. The game system according to claim 1, wherein the command comprises pixel data for video reconstruction, position and offset for video reconstruction, sequence for video reconstruction, or information for audio reconstruction.

8. A command distribution method comprising steps:
receiving a command from a game platform;
identifying a type to which the command corresponds among a plurality of types; and
transmitting the command to a corresponding data engine for processing according to the identified type to generate an output signal.

9. The command distribution method according to claim 8, wherein the transmitting step transmits the command to a corresponding driver according to the identified type, and then transmits the command via the corresponding driver to the corresponding data processing engine.

10. The command distribution method according to claim 8, wherein the command is a multimedia command in a predetermined format with a defined command identification (ID), by which the multimedia command identifies a type to which the multimedia command corresponds.

11. The command distribution method according to claim 10, wherein the multimedia command in the predetermined format comprises types of a single command and a packet command; wherein the single command comprising of a command ID, a data size and data; and the packet command comprising of a command ID, a data size, data and packet data; and a null command.

12. The command distribution method according to claim 10, wherein the command includes pixel data for video reconstruction, position and offset for video reconstruction, sequence for video reconstruction, or information for audio reconstruction.

13. The command distribution method according to claim 8, wherein the data processing engine is a graphic engine, an audio engine or a video engine, and the output signal is a video signal, a graphic signal, an audio signal, or an audio/video signal.

14. A command distribution method for use in a game platform and an audio/video playing device, comprising steps of:
producing a command with a command ID from a built-in driver set in the game platform and transmitting the command to the audio/video playing device;
receiving the command by the audio/video playing device;
identifying a type to which the command corresponds among a plurality of types according to the command ID; and
transmitting the command to a data processing engine set for processing to generate an output signal.

15. The command distribution method according to claim 14, wherein the transmitting step transmits the command to a corresponding data processing engine among a plurality of data processing engines according to the identified type to generate the output signal.

16. The command distribution method according to claim 15, wherein the audio/video playing device transmits the command to a driver corresponding to the identified type, and sends the command via the driver to the data processing engine corresponding to said type.

17. The command distribution method according to claim 14, wherein the multimedia command in the predetermined format comprises types of a single command and a packet command; wherein the single command comprising of a command ID, a data size and data; and the packet command comprising of a command ID, a data size, data and packet data; and a null command.

18. The command distribution method according to claim 14, wherein the command includes pixel data for video reconstruction, position and offset for video reconstruction, sequence for video reconstruction, or information for audio reconstruction.

19. The command distribution method according to claim 14, wherein the data processing engine set comprises a graphic engine, an audio engine and a video engine.

20. The command distribution method according to claim 14, wherein the output signal is a video signal, a graphic signal, an audio signal or an audio/video signal.
